(19) United States
(12) Patent Application Publication
(10) Pub. No.: US 2024/0116463 A1
(43) Pub. Date: Apr. 11, 2024

(54) SANITARY RV WASTE DISPOSAL SYSTEM

(71) Applicants: Deborah Glode Smith, Brunswick, GA (US); Thomas Lewis Smith, Brunswick, GA (US)

(72) Inventors: Deborah Glode Smith, Brunswick, GA (US); Thomas Lewis Smith, Brunswick, GA (US)

(21) Appl. No.: 18/371,473

(22) Filed: Sep. 22, 2023

Related U.S. Application Data
(60) Provisional application No. 63/413,989, filed on Oct. 7, 2022.

(51) Int. Cl. B60R 15/00; F16L 21/06

(52) U.S. Cl. CPC B60R 15/00; F16L 21/06

(57) ABSTRACT

The invention relates to a device and method whereas the sewage dumping process for an RV is a more sanitary process keeping people from coming in direct contact with raw sewage and bacteria from un-sanitized hoses.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants make no claim to any trademarks reference.

### REFERENCE TO RELATED APPLICATIONS

This application claims the benefit of U.S. Provisional patent Application Ser. No. 63/413,989, filed on Oct. 7, 2022, which is incorporated by reference herein in its entirety.

### BACKGROUND OF THE INVENTION

### 1) Field of the Invention

This invention relates to the field incorporating a method and device for sanitary RV waste disposal.

### 2) DESCRIPTION OF RELATED ART

Currently, the state of art includes the removal of sewage from a Recreational Vehicle (RV) using closed hoses and fittings to connect to the dumping station or a sewage hook up. The process exposes people to raw sewage, bacteria, germs, mold, mildew and viruses from hoses and items used to facilitate sewage removal. These devices are not easily sanitized between uses.

Recreational vehicles (“RVs”) and mobile homes are routinely used for camping trips, road trips, or can even serve as a temporary or permanent home. They are suitable for travel and living because they may have a kitchen or bathroom contained within the vehicle. Therefore, RVs and mobile homes generally feature a storage system for sewage and waste with an external hose that can connect to an RV and provide a means to empty the sewage and waste into a sewage disposal area. The typical process is that a closed hose is connected to an RV and to a sewage hookup to allow for sewage and waste to travel from the RVs waste system to the sewage hookup. This connection must be disconnected when the RV is moved. To accomplish this, the hose needs to be disconnected and stored on the RV. When disconnecting the sewer hose from the RV, the inside of the hose is littered with bacteria and fecal matter. Even if you rinse it thoroughly, the hose can still be contaminated with bacteria and fecal matter, which can cause an unpleasant odor.

These and other objects, features, and advantages of the present invention will become more readily apparent from the attached drawings and the detailed description of the preferred embodiments, which follow.

### BRIEF SUMMARY OF THE INVENTION

The instant invention provides a method for dumping RV sewage that is more hygienic, preventing exposure to untreated sewage and bacteria from dirty hoses.

After disposal of wastewater, the device of the instant invention can be sanitized, thereby removing the risk of exposure to bacteria, viruses and cross contamination to other RV contents.

The instant invention in one form is directed to the use of a plastic sleeve, the raw sewage flows through the inside of the sleeve, removing contact with other surfaces and people The instant invention design ensures a tight seal over the RV discharge hose and prevents leaks and human contact with raw sewage. The sleeve can be easily adjusted within the waste hose using the open top. The waste hose open design allows the user to sanitize the inside of the hose as well as the outside after removal of the plastic sleeve.

This instant invention is designed so that it can replace the traditional RV waste line connecting devices so it can be easily used by RV owners. This creates a potentially large market because there are over 44 million RV owners in the U.S.

These and other objects, features, and advantages of the present invention will become more readily apparent from the attached drawings and the detailed description of the preferred embodiments, which follow.

### BRIEF DESCRIPTION OF DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 there is shown an exploded view of the RV sewage disposal system of the instant invention.

FIG. 2, there is a perspective side view showing the top of the split hose.

FIG. 3 there is a perspective side view showing the bottom of the split hose.

FIG. 4 there is shown a perspective sideview of the split hose.

FIG. 5 there is shown a view of the instant invention attached to the RV and a typical sewage dumping station.

FIG. 6 there is shown a typical connecting end of the split hose.

FIG. 7 there is shown a typical connecting elbow to facilitate connection of the RV to the sewage dumping station.

FIG. 8 there is shown a disposable connecting sleeve used to connect the RV to the sewage dumping station.

FIG. 9 there is shown an optional cover for split hose shown in FIG. 2.

FIG. 10 there is shown a quick connect plate for connecting the RV to the sewage dumping station that can replace the typical connecting end of the split hose.

FIG. 11 is a typical kit of the invention.

FIG. 12 shows the connector used to secure the sleeve to the threaded connectors.

FIG. 13 shows a cutaway cross-sectional view through the direction of sewage flow of the sleeve held in place at the pipe elbow by the magnetic connector and the magnetic connect plate.

FIG. 14 shows cutaway cross-sectional view through the direction of sewage flow of the second small liner held in place by a gasket.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms RV and Recreational Vehicle are used interchangeably to mean any vehicle which has a sewage collection and retention system and can include a trailer, a self-contained vehicle, a boat or other type of vehicle.

The term sewage collection system as used in the specification is meant to mean either a sewage or grey water collection and storage system.

Prior to a discussion of the preferred embodiment of the invention, it should be understood that while the features and advantages of the invention are illustrated in terms of a sewage collection system that the system could be used for any fluid transfer process.

The instant invention solves the problem of contact by a user of an RV with the connecting device used with an RV waste disposal system by removing contact between people and raw sewage during the sewage removal process and lowering the risk of cross contamination from sewer hoses stored in campers that breed bacteria, mold, mildew, germs, and harbor viruses. Covid 19 as well as many other diseases are detectable in human waste making exposure a risk to humans.

The instant invention is a system that replaces the existing hose with a hose system comprised of a split hose, a disposable sleeve and quick connect connector or plates that are designed to connect the waste disposal connection of and RV or camping equipment to a waste dumping station or waste collection system. The invention provides an easier, faster, cleaner, and safer, disposal and emptying method for emptying sewage tanks or creating a direct connection between the RV and the waste dumping/collection system. The disposable sleeve of the instant invention provides the user the ability to connect an RV or any other mobile sewage tank to a collection system such as a dump station or sewage connection with a self-contained and easy to handle conduit thereby lowering the risk of cross contamination to RV contents. The disposable sleeve eliminates the contact of traditional hose systems that can come into contact with the RV and thereby provide a method for bacteria, germs, mold, mildew, and viruses to contaminate the RV and its equipment. Hoses and items used in sewage removal cannot be sanitized adequately due to inability to reach all areas inside and outside of closed hoses. Currently, it is necessary to empty sewage with a closed hose. After use the user must pick up the closed-in hose after removal of sewage from the RV or vehicle and raise the closed-in hose above the rest of the hose continuing along the entire length until you reach the end at the disposal pipe which helps to remove some of the left-over sewage contained in the hose. Then the user must rinse the closed-in hose after use to remove additional fecal and other waste materials. The rinsing process is ineffective and exposes people to bacteria and viruses found in sewage. Furthermore, rinsing can only remove some sewage and not all fecal matter and other waste materials is removed from the hose. The inability to thoroughly clean the hose provides a perfect environment for bacteria growth, mold, mildew, and spread of germs through cross contamination to any surface that encounters an unsanitary sewer drain hose as well as other items used in waste disposal. The instant invention comprises of the split hose, connectors and disposable sleeve provides a means for the user to avoid direct contact with the raw sewage due to the open configuration of the sewage split hose along with the disposable sleeve. The quick connect plates provide a method to seal the disposable sleeve to the RV/vehicle and the dumping station or sewage collection system connector. The instant invention prevents the sewage from contact with the split hose surface thereby creating a sanitary process for handling sewage from the RV. The split hose configuration allows access to the inside surfaces for disinfection prior to storage. This allows for more sanitary storage, minimizing the risk of cross contamination. The optional cover can be fixed or removable and can be used, if desired, to close the top opening during removal of sewage from the RV or if the hose is left in place longer than the time needed for disposal.

The disposable sleeve can use the quick connect plates, strapping, Velcro (also known as hook and loop connectors), clamps, beaded cable ties, cable tie (also known as a hose tie, zip tie, or tie wrap) to secure the disposable sleeve to the output of the RV or the input of the sewage collection system or dump station.

As noted, the instant invention is used by a person who is emptying the RV waste collection and storage system and it is intended to cover all alternatives, modifications and equivalents as may be included within the spirit and scope of the inventions as defined in the appended claims.

The device of the instant invention is a flexible, partially flexible, or ridged hose or any combination thereof with an opening running the length of the hose or optionally partially open and closed across the top of the hose or any combination thereof, attaching to the RV sewage tank or outlet pipe and running to the disposal pipe of the disposal tank. A disposable sleeve is placed inside of the opening for the sewage water and associated waste to flow into the disposal system or dumping station. The disposable sleeve creates a path for the sewage to travel through and the disposable sleeve to the dumping station or sewage system collection point. The disposable sleeve is supported in a spit hose that cradles the disposable sleeve. The split hose and sleeve in combination with the quick connect plates provide a sanitary method to connect a sanitation system of an RV to a dump station or sewage collection system. The disposable sleeve captures and prevents the transmission of waste from coming in contact with a user. It allows the user to dispose of the sleeve in a safe and sanitary manner without contamination of the split hose, as well as allowing disinfection of the inside of the hose after completion of emptying of the sewage tank or waste outlet on the RV. Optionally, this split hose can be used with a sleeve, or, without a sleeve. If used without a sleeve the opening allows access to all areas of the hose but will take meticulous disinfection prior to storage. Due to the ability to reach all areas of the inside of the hose, complete disinfection can be achieved.

The device further includes inner quick connect plates on each end of the hose that connect to the outer origination plate that connects to the pipe from the RV sewage tanks, as well as the outer termination plate that connects to the pipe that empties into the sewage disposal tanks. Optionally, other connection mechanisms can be used to connect the hose to the beginning and ending termination pipes.

The instant invention comprises the following components.

The “RV” Wastewater Split-Hose has an opening at the top of the hose running the length of the hose. The hose is made with a inner quick connect plate at the RV side and a quick connect plate at the termination side of the hose. The inner quick connect plate and alternatively can replaced with a connector such as a strapping, Velcro (also known as hook and loop connectors), clamps, beaded cable ties, cable tie (also known as a hose tie, zip tie, or tie wrap) to secure the disposable sleeve to the output of the RV. The quick connect plate at the termination side of the hose alternatively can replaced with a connector such as a strapping, Velcro (also known as hook and loop connectors), clamps, beaded cable ties, cable tie (also known as a hose tie, zip tie, or tie wrap) to secure the input of the sewage collection system or dump station.
a. The split hose is made of flexible expanding hose. Alternatively, the hose can be made of alternating flexible expanding type of hose and solid hose or any combination of available hose types such as rubber, nitrile tube and cover, PVC, EPDM, SBR, and metal which are a few of the available types. The opening running the length of the hose can be partially open and closed or any combination thereof, Alternatively the quick connects can be made of any material and any type of connection that will allow the hose to be connected to the RV pipe or attachment points made onto the pipe from the manufacturer, or any combination thereof. The split hose can alternatively be formed from multiple flat or curved pieces that fit together to form an open top shape.
b. The hose-quick connect plate attaches to the quick connect plate installed on the 4″×3″ RV pipe.
c. The spit hose termination end quick connect plate attaches to the connect plate made on the termination reducer which is then placed into the dumping station pipe.
d. The split hose is placed on a standard U-shaped stabilizer placed on the ground or supported by standoffs, so the hose does not lay on the ground. The U-shaped stabilizer keeps the hose in a fixed position, so it does not twist.
e. A disposable sleeve or liner is placed into the middle of the hose. The user fluffs the liner to allow air to enter the liner.
f. The liner is composed of plastic or any available non-porous disposable material.
g. On the RV side, the liner extends through the middle of the open split hose and plate, while the 4″ to 3″ reducer is attached to the split hose. The liner is then placed on to the RV pipe. The reducer with a gasket, around the inside, is disconnected from the hose and then placed over the liner to seal the liner from leaks. The split hose is then reconnected to the reducer and completes the hose connection on the RV side.
h. The bottom of the termination reducer liner is rolled onto the outside of the reducer.

The termination reducer is then placed into the dump station pipe.
j. The user or person then opens the gray water valve for 30 seconds to allow fluid into the liner. The user will then check for any blockage in the line prior to disposal of the black water tank.
k. After confirming proper water flow and no blockage, the user can continue with wastewater disposal as normal. Drain the black water tank and flush the tank with water to insure proper complete disposal per your RV instruction manual. Close the black water tank and open the gray water tank for disposal. Close gray water tank.
l. The user will then unhook the outer RV quick connect plate from the reducer on the RV side. Seal the end and pull the additional liner from the RV pipe placing it into a disposal bag. Continue down the length of the sewage hose picking up the liner and draining the fluid towards the disposal tank until you reach the termination reducer. Disconnect the hose from the reducer.
m. The user will then tie off the additional sleeve/liner at the end of the sleeve/liner to prevent any additional fluid from escaping. then pulling the rest of the sleeve/liner from the disposal pipe reducer and places it in the disposal bag.
n. The user will then spray all the parts used for disposal with a sanitizer. Once sanitized and dry to the touch and the user can repack the instant invention into the carrying case.

Alternatively:
A. The “RV” Wastewater Hose has an opening at the top of the hose running the length of the hose. The hose is made with a quick connect plate at the RV side and termination side of the hose. The Hose is made of flexible expanding hose. Alternatively, the hose can be an alternating flexible expanding and solid hose or any combination of available hose types, alternatively. the opening running the length of the hose can be partially open and closed or any combination thereof, Alternatively the quick connects can be made of any material and any type of connection that will allow the hose to be connected to the RV pipe or attachment points made onto the pipe from the manufacturer, or any combination thereof.
B. A disposable liner is placed over the discharge pipe on the RV prior to the hose being connected. The sleeve is fluffed to allow air to enter the liner, which is run to the end of the hose, through the 90-degree elbow reducer and into the sewer seal. It is then rolled onto the outside of the sewer seal.
C. The liner is composed of plastic or alternatively any available non-porous disposable material.
D. On the RV side, the open top hose and quick connect attach to the RV discharge pipes.
E. The hoses termination quick connect plate, which is attached to the 90-degree elbow—termination reducer, then attached to the sewer seal is then placed into the dumping station pipe.
F. The hose is placed on a U-shaped hose support stabilizers placed on the ground, which keeps the hose in a fixed position, so it does not twist while allowing the correct angle to facilitate the flow of fluid.
G. After sewage removal is completed, the user will then unhook the quick connect on the RV side. Seal the liner end and pull the liner from the RV pipe through the open top and place it into a disposal bag. They will continue down the length of the sewage hose picking up the liner and draining the fluid towards the disposal tank and placing it into the storage bag, until you reach the sewer seal.
H. Pulling down the outer sleeve from the outside of the seal. Tie off the end of the sleeve pull the rest of the sleeve from the hose and place it in the disposal bag, Throw the disposal bag in the dump station trash can.
I. The user will then spray all the parts used in the disposal process with your preferred sanitizer. Leave until dry to the touch and repack into the carrying case.

The unique features of the instant invention include.
1. A flexible, partially flexible, or ridged split hose or any combination thereof. The hose has an opening at the top of the split hose running the length of the split hose or, alternatively, the opening running the length of the hose that can be partially open and closed or any combination thereof. The opening provides the user the ability to reach all areas of the hose for disinfection of the inside of the hose after completing the emptying of the sewage tanks.
2. A sleeve/liner is placed inside of the opening for the sewage collection system or dumping station to allow the fluid to flow into the sewage collection system. The sewage sleeve creates a path for the sewage to travel through the hose in a sanitary fashion without contamination of the split hose.
3. Optionally, this split hose can be used with a sleeve/liner, or, while not ideal, without a sleeve. A second benefit of the design is if the split hose is used without a sleeve, the opening of the split hose allows access to all areas of the hose for meticulous disinfection prior to storage.
4. The apparatus of the instant invention further includes optional inner quick connect plates on each end of the hose that connect to the outer origination plate that connects the pipe from the RV sewage tanks, as well as the outer termination plate that connects to the pipe that empties into the sewage disposal fitting. Optionally, other connection mechanisms can be used to connect the hose to the beginning and ending termination pipes such as strapping, Velcro (also known as hook and loop connectors), clamps, beaded cable ties, cable tie (also known as a hose tie, zip tie, or tie wrap) to secure the disposable sleeve to the output of the RV or the input of the sewage collection system or dump station.
5. The apparatus of the instant invention further includes an optional, removable, or fixed hose opening cover with a C Channel on each side, which may be used during the removal of the sewage if desired. Optionally: a cover can be used to cover the pipe opening if the hose is left disconnected for a long period of time. The hose cover can alternatively be fixed or removal.

The assembly of all the items into a kit makes the installation simple and easy for the user because the parts necessary to connect the RV sewage disposal system to a pump out or dump receiving system for the stored waste. The kit could contain a split hose, at least one sleeve and the necessary connectors for use by an individual to empty an RV sewage or waste disposal system. The kit could also be provided with the necessary tools such as a wrench or screwdriver needed to connect all the pieces and connect the split hose and sleeve to the RV and disposal system.

A first preferred embodiment comprised of a waste connection device for use with an recreational vehicle comprising a split hose, at least one split hose connector, a sleeve, at least one sleeve connector, and said waste connection device is enabled to connect to an RV sewage discharge pipe when said sleeve is placed inside said split hose such that sewage water can flow through said sleeve to a disposal device and said sleeve creates a path for said sewage so that said sewage can flow through said sleeve and does not contact said split hose there by preventing the contamination of said split hose.

The hose system of the instant invention wherein the material comprising said split hose is selected from the group consisting of PVC, aluminum, steel, stainless-steel, High-Density Polyethylene (HDPE) and fiberglass.

The hose system of the instant invention wherein the material comprising said sleeve is selected from the group consisting of polyethylene, PVC, polypropylene or High-density polyethylene (HDPE).

The hose system of the instant invention wherein the material comprising at least one second small liner is selected from the group consisting of polyethylene, PVC, polypropylene or High-density polyethylene (HDPE).

The hose system of the instant invention wherein the at least one sleeve connector is selected from the group consisting of a magnetic connector and typical threaded connector.

A kit forming the waste connection device of the instant invention comprising a split hose, at least one split hose connector, a sleeve and at least one sleeve connector.

A second preferred embodiment comprised of a waste connection device for use with an recreational vehicle comprising a split hose, at least one split tube connector, a sleeve, at least one sleeve connector, at least one magnetic connection plate, at least one magnetic connector, at least one second small liner, and said waste connection device is enabled to connect to an RV sewage discharge pipe and said sleeve is placed inside said split hose such that sewage water can flow through the sleeve to a disposal device and said sewage sleeve creates a path for said sewage water so that said sewage water can flow through said sleeve and does not contact said split hose there by preventing the contamination of said split hose.

The hose system of the instant invention wherein the material comprising said split hose is selected from the group consisting of PVC, aluminum, steel, stainless-steel, High-Density Polyethylene (HDPE) and fiberglass.

The hose system of the instant invention wherein the material comprising said sleeve is selected from the group consisting of polyethylene, PVC, polypropylene or High-density polyethylene (HDPE).

A kit forming the waste connection device of the instant invention comprising of split hose, at least one split tube connector, a sleeve, at least one sleeve connector, at least one connection plate, at least one connector.

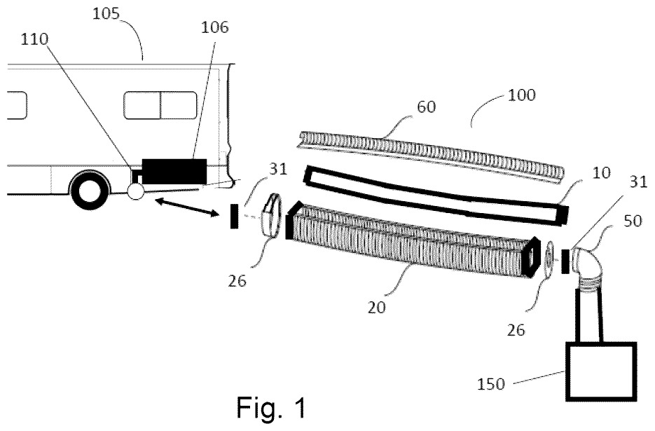

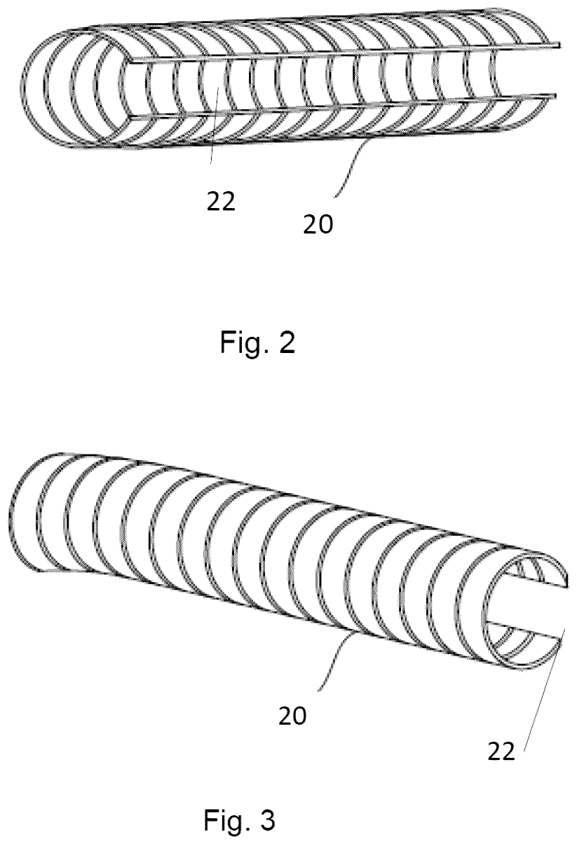

Referring now to the drawings FIG. 1-14, and more particularly to FIG. 1, there is shown an RV sewage disposal system 100 comprised of a flexible, partially flexible, or ridged split hose 20 or any combination thereof. The split hose 20 has an opening or slit 22 (shown in FIG. 2). at the top of the split hose 20 running the length of the split hose 20. Alternatively, the opening 22 can run the length of the split hose 20 such that it can be partially open and closed or any combination thereof. The opening provides the ability to reach all areas of the hose for disinfection of the inside of the split hose 20 after the emptying of the sewage tanks or system is completed. The split hose 20 can have an optional top 60 that is used to complete the circumference of split hose 20. The optional top 60 provides a method to enclose the split hose 20 so that the sleeve 10 is not exposed when unattended.

A sleeve 10 is placed inside of the opening 22. The split hose 20 is connected to the sewage output pipe 110 from the RV 105. Sewage pipe 110 is connected to Sewage tank 106 and the pipe elbow 50 is connected to the sewage disposal tank 150 or disposal system(not shown). The split hose 20 has a connector 26 on each end. The connector 26 can be either magnetic or manual twist on device or use any suitable connection method. The sleeve 10 provides a sanitary connection that allows the sewage water to flow into the disposal system or tank 150. The sleeve 10 creates a path for the sewage to travel through in a sanitary fashion without contaminating the split hose 20.

Optionally, this split hose 20 can be used with sleeve 10, or, while not ideal, without a sleeve 10. If the split hose 20 is used without sleeve 10 the opening or slit allows access to all areas of the split hose 20 for meticulous disinfection prior to storage.

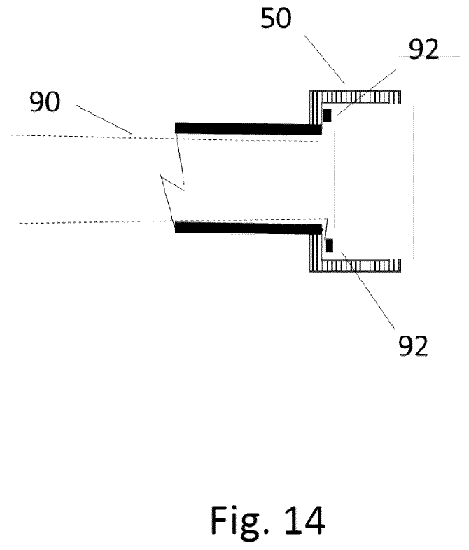

The instant invention can also include inner quick connection plate 27 (shown in FIG. 13) on each end of the hose that connects to the outer termination fixtures 31. The pipe 110 from the RV 105 sewage tanks 106, is connected to a first outer termination fixture 31. A second outer termination fixture 31 can connect the pipe elbow 50 that empties into the sewage disposal tanks 150 into the disposal system. Alternatively, the sewage disposal tanks 150 having pipe elbow 50 can also have a second small liner 90 and a gasket 92 to hold it in place as shown in FIG. 14. Optionally, other connection mechanisms can be used to connect the hose to the beginning and ending termination pipes such as but not limited to quick connect plates, strapping, Velcro (also known as hook and loop connectors), clamps, beaded cable ties, cable tie (also known as a hose tie, zip tie, or tie wrap) to secure the disposable sleeve to the output of the RV or the input of the sewage collection system or dump station. These connection methods would replace the connector 26. Connector 26 can also be a magnetic connector or a quick connect plate 27 and the connection plate 28 as shown in FIG. 13.

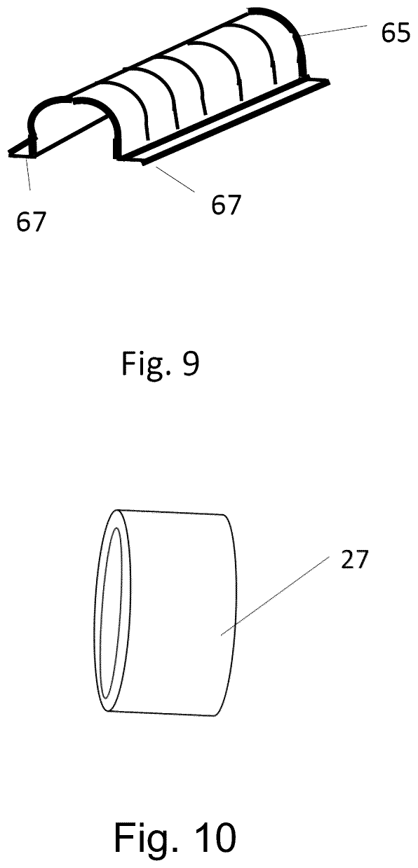

The instant invention can also include an optional, removable, or fixed hose opening cover 65 with a connector 67 on each side shown in FIG. 9, which may be used during the removal of the sewage if desired. Optionally: cover 60 can be used to cover split hose 20 opening if hose is left for a longer period of time. Cover 60 can be fixed or removable.

The sleeve 10 is made from a flexible material such as polyethylene, PVC, polypropylene, or High-density polyethylene (HDPE).

FIG. 2, there is a perspective side view showing the top of the split hose 20 and opening or slit 22 at the top of the split hose 20 running the length of the split hose 20. Split hose 20 can be formed from a corrugated or smooth pipe. The construction is preferably plastic but any suitable material such as PVC, aluminum, steel, stainless-steel, High-Density Polyethylene (HDPE) or fiberglass.

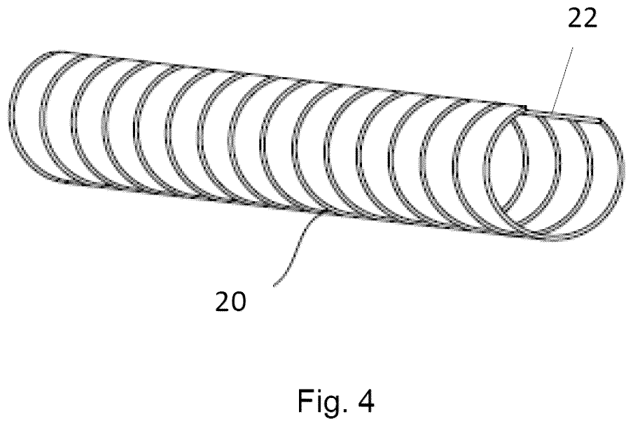

FIG. 3 is a perspective side view showing the bottom of the split hose 20 showing the opening or slit 22.

FIG. 4 is a perspective side view of the split hose 20 showing the opening or slit 22.

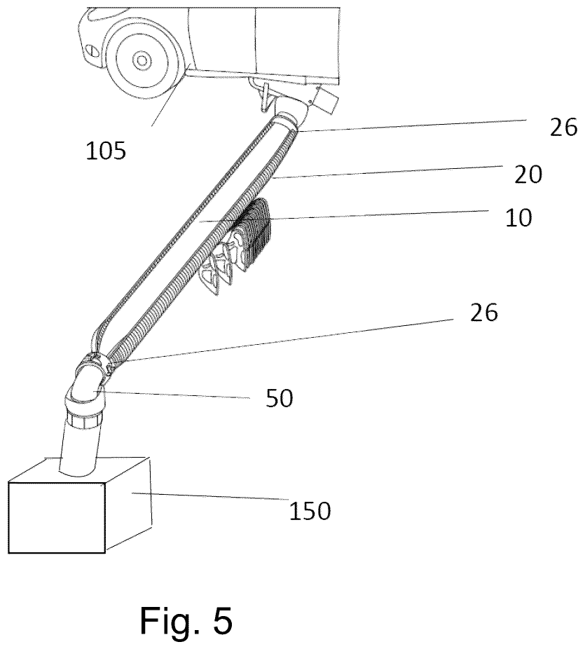

FIG. 5 is a view of the instant invention split hose 20, sleeve 10, connectors 26, attached to the RV 105, pipe elbow 50 and a typical sewage disposal tank 150 or system.

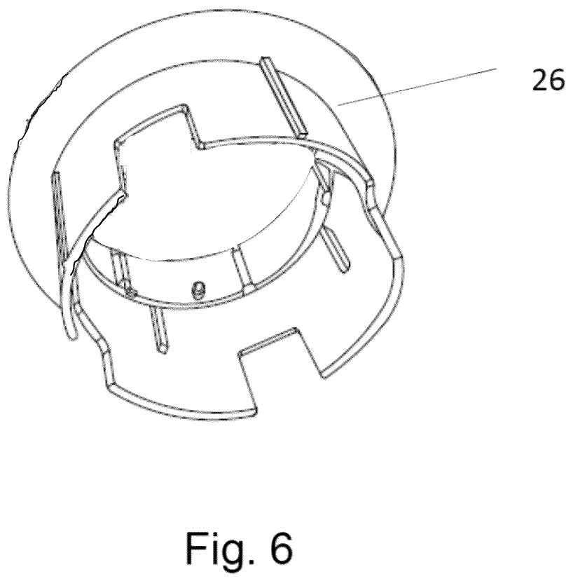

FIG. 6 shows a typical threaded connector 26 for use with the split hose 20 (shown in FIG. 1).

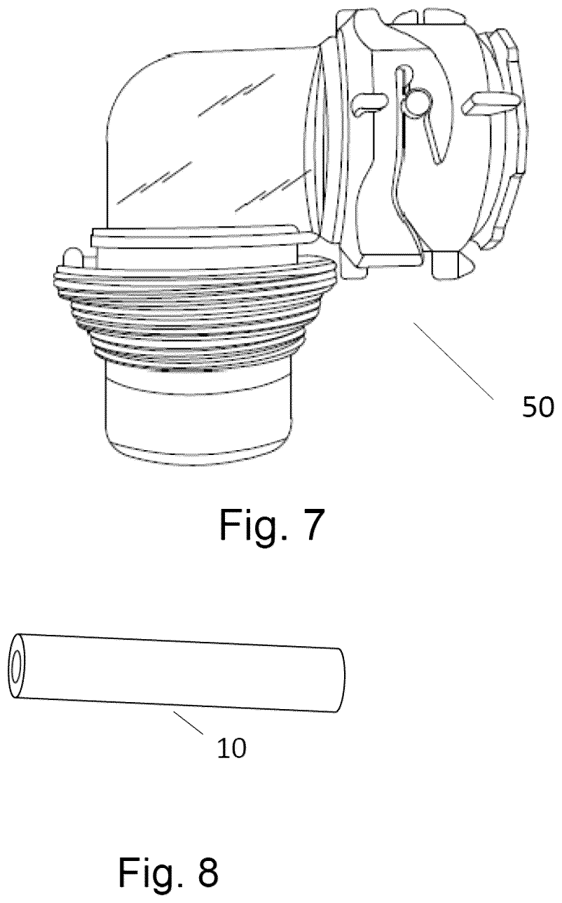

FIG. 7 shows a typical connecting pipe elbow 50 to facilitate the connection of the RV to the sewage dumping station.

FIG. 8 shows a disposable sleeve 10 used to connect the RV to the sewage dumping station. The length can be any suitable size to allow a user to connect the RV to the sewage disposal. In one embodiment, the sleeve 10 could be on a roll and the sleeve 10 would be cut by the user to length to ensure that the sleeve is the proper length.

FIG. 9 there is shown an optional cover 65 for split hose shown in FIG. 2 The optional cover has connector 67 that facilitate the cover 65 being held in place on split hose 20 and covering slit 22.

FIG. 10 there is shown a typical quick connect plate 27 alternatively used in place of or with connector 26.

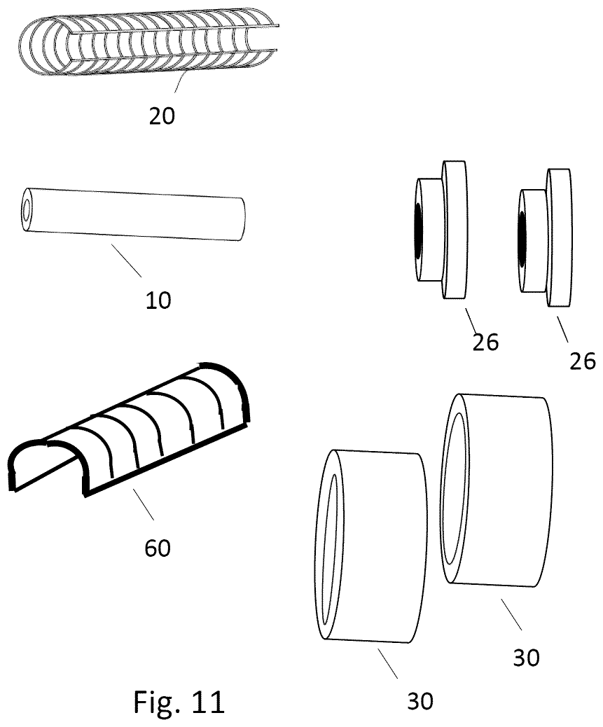

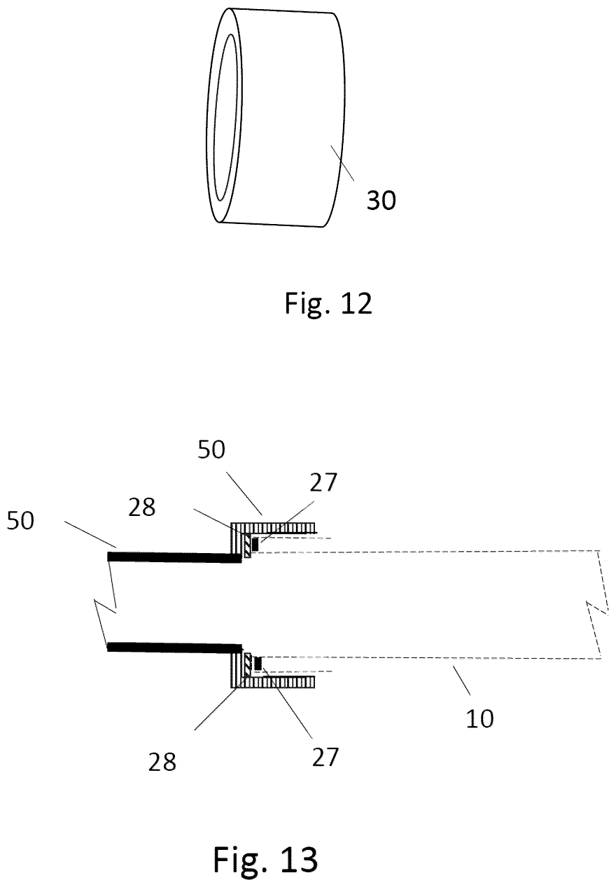

FIG. 11 is a typical kit of the invention. The kit contains at least 1 sleeve, 10, a split hose 20, two threaded connectors 26, a cover 60 for the split hose 20, two connectors 30 (shown in FIG. 12) to attach the sleeve 10 to the two threaded connectors 26. However, the kit could contain any of the parts identified in the specification such as but not limited to second small liner 90 held in place by the gasket 92 and hose opening cover 65.

The second small liner 90 is made from a flexible material such polyethylene, PVC, polypropylene, or High-density polyethylene (HDPE).

The gasket 92 can be made from a flexible material such as rubber, synthetic rubber, polyethylene, PVC, polypropylene, or High-density polyethylene (HDPE), butadiene rubber, styrene-butadiene rubber, neoprene, the polysulfide rubbers (thiokols), butyl rubber, and silicones.

FIG. 12 connector 30 used to secure the sleeve 10 (shown in FIG. 1) to the threaded connectors 26 (shown in FIG. 1).

FIG. 13 is a cutaway cross-sectional view through the direction of sewage flow, the sleeve 10 is held in place at the pipe elbow 50 by the quick connect plate 27 the connection plate 28. This configuration can also be used on the Recreational vehicle side of the assembly of the instant invention.

FIG. 14 cutaway cross-sectional view through the direction of sewage flow, shows the second small liner 90 held in place by the gasket 92. This configuration can also be used on the Recreational vehicle side of the assembly of the instant invention.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

We claim:

1. A waste connection device for use with an recreational vehicle comprising: a split hose, at least one split hose connector, a sleeve, at least one sleeve connector.

2. The method of using the waste connection device claim 1 wherein said sleeve is connected to an recreational vehicle sewage discharge pipe with said at least one sleeve connector and said sleeve is placed inside said split hose and said sleeve is connected to a disposal device using at least one sleeve connector and said split hose and said split hose is connected to said recreational vehicle sewage discharge pipe with said at least one split hose connector and said split hose is connected to a disposal device using at least one split hose connector such that sewage water from said recreation vehicle can flow through said sleeve to said disposal device such that said sleeve creates a path for said sewage so that said sewage can flow through said sleeve and does not contact said split hose there by preventing the contamination of said split hose.

3. The hose system of claim 1 wherein the material comprising said split hose is selected from the group consisting of PVC, aluminum, steel, stainless-steel, High-Density Polyethylene (HDPE) and fiberglass.

4. The hose system of claim 1 wherein the material comprising said sleeve is selected from the group consisting of polyethylene, PVC, polypropylene or High-density polyethylene (HDPE).

5. The hose system of claim 1 wherein the material comprising said at least one second small liner is selected from the group consisting of polyethylene, PVC, polypropylene or High-density polyethylene (HDPE).

6. The hose system of claim 1 wherein the at least one sleeve connector is selected from the group consisting of a magnetic connector and typical threaded connector, Velcro, clamps, beaded cable ties, cable tie (also known as a hose tie, zip tie, and tie wrap.

7. A kit forming the waste connection device of claim 1 comprising a split hose, at least one split hose connector, a sleeve and at least one sleeve connector.

8. A waste connection device for use with an recreational vehicle comprising a split hose, at least one split tube connector, a sleeve, and at least one quick connection connector.

9. The method of using the waste connection device claim 8 wherein said sleeve is connected to an recreational vehicle sewage discharge pipe with said at least one quick connection connector and said sleeve is placed inside said split hose and said sleeve is connected to a disposal device using at least one quick connection connector and said split hose and said split hose is connected to said recreational vehicle sewage discharge pipe with said at least one split hose connector and said split hose is connected to a disposal device using at least one split hose connector such that sewage water from said recreation vehicle can flow through said sleeve to said disposal device such that said sleeve creates a path for said sewage so that said sewage can flow through said sleeve and does not contact said split hose there by preventing the contamination of said split hose.

10. The hose system of claim 8, wherein the material comprising said split hose is selected from the group consisting of PVC, aluminum, steel, stainless-steel, High-Density Polyethylene (HDPE) and fiberglass.

11. The hose system of claim 8 wherein the material comprising said sleeve is selected from the group consisting of polyethylene, PVC, polypropylene or High-density polyethylene (HDPE).

12. The hose system of claim 8 at least one quick connection connector is made of plastic.

13. A kit forming the waste connection device of claim 8 comprising a split hose, at least one split tube connector, a sleeve, at least at least one quick connection connector.

14. A waste connection device for use with an recreational vehicle comprising a split hose, a sleeve, at least one split hose connector, at least one magnetic quick connection connector.

15. The method of using the waste connection device claim 14 wherein said sleeve is connected to an recreational vehicle sewage discharge pipe with said at least one one magnetic quick connection connector and said sleeve is placed inside said split hose and said sleeve is connected to a disposal device using at least one one magnetic quick connection connector and said split hose and said split hose is connected to said recreational vehicle sewage discharge pipe with said at least one split hose connector and said split hose is connected to a disposal device using at least one split hose connector such that sewage water from said recreation vehicle can flow through said sleeve to said disposal device such that said sleeve creates a path for said sewage so that said sewage can flow through said sleeve and does not contact said split hose there by preventing the contamination of said split hose.

16. The hose system of claim 17, wherein the material comprising said split hose is selected from the group consisting of PVC, aluminum, steel, stainless-steel, High-Density Polyethylene (HDPE) and fiberglass.

17. The hose system of claim 17 wherein the material comprising said sleeve is selected from the group consisting of polyethylene, PVC, polypropylene or High-density polyethylene (HDPE).

18. A kit forming the waste connection device of claim 8 comprising a split hose, at least one split tube connector, a sleeve, one magnetic quick connection connector.
